(19) United States
(12) Patent Application Publication
(10) Pub. No.: US 2018/0267652 A1
(43) Pub. Date: Sep. 20, 2018

(54) TOUCH PANEL

(71) Applicant: ILJIN DISPLAY CO., LTD., Chungcheongbuk-Do (KR)

(72) Inventors: Jun Sik KANG, Daejeon (KR); Ji Eun HWANG, Gangwon-Do (KR); Kyun AHN, Gyeongsangnam-do (KR); Kwang Hyun KIM, Seongnam-si (KR); Bong Ho KIM, Morganville, NJ (US); Ki Hwan KIM, Seoul (KR)

(21) Appl. No.: 15/759,629

(22) PCT Filed: Jul. 7, 2016
(86) PCT No.: PCT/KR2016/007345

§ 371 Date: Mar. 13, 2018

(30) Foreign Application Priority Data
Aug. 10, 2015 (KR) 10-2015-0112370

(51) Int. Cl. G06F 3/047; G06F 3/041

(52) U.S. Cl. CPC G06F 3/047; G06F 3/0412

(57) ABSTRACT

The touch panel comprises: a first transparent substrate divided into an active area and a non-active area located around the active area; a sensing pattern part that includes first sensing cells arranged in the active area of the transparent substrate in the longitudinal direction, a second transparent substrate provided on the first sensing cells, and second sensing cells arranged on the second transparent substrate in the lateral direction; and first sensing lines and second sensing lines provided in the non-active area of the first transparent substrate to connect the first sensing cells and the second sensing cells to an external driving circuit, respectively, wherein an extended transparent substrate extending from the second transparent substrate along the interconnection wires of the second sensing cells is formed in the non-active area of the first transparent substrate.

### TECHNICAL FIELD

The present invention relates to a touch panel, and more particularly, to a touch panel including a sensing pattern having a two-layer structure.

### BACKGROUND ART

A touch panel is an input device included in an image display device or the like and enabling a user command to be input by using a human hand or an object. To this end, the touch panel is provided on the front of the image display device or the like and converts a contact position, which is brought into direct contact with the human hand or the object, into an electrical signal, so that the contents selected at the touch position are received as an input signal. Since the touch panel can replace a separate input device, such as a keyboard and a mouse, which is connected to the image display device, the use range of the touch panel is gradually expanding.

As a method of implementing a touch panel, a resistive type touch panel, a light sensing type touch panel, and a capacitive type touch panel are known. The capacitive type touch panel converts a contact position into an electrical signal by sensing a change in capacitance that a conductive sensing pattern forms with other surrounding sensing patterns or a ground electrode when a human hand or an object is touched.

Such a touch panel is generally manufactured separately and attached to an outer surface of a display panel of an image display device such as a liquid crystal display device or an organic light-emitting display device. A window substrate is further provided on the upper surface of the touch panel so as to improve the strength of the mechanism.

The touch panel includes a transparent electrode film having a transparent electrode pattern formed on a transparent film. Such a transparent electrode pattern may be formed on one transparent film. The transparent electrode pattern may be formed on each of two transparent films, and then two transparent electrode films may be vertically stacked. Such a transparent electrode film layer may be bonded to a window panel by an optical clear adhesive (OCA) or the like to constitute a touch panel.

In the case of a two-layer type touch panel in which two transparent electrode films are vertically stacked, there is a problem that connection lines for electrically connecting with an external circuit essentially form a stepped structure, thus causing an increase in manufacturing process and a deterioration in quality.

### DETAILED DESCRIPTION OF THE INVENTION

### Technical Problem

The present invention provides a touch panel having a structure capable of shortening a metal patterning process for forming a sensing pattern having a two-layer structure and sensing lines or reducing a space of a non-active area for arranging the sensing lines.

### Technical Solution

A touch panel according to the present invention includes: a first transparent substrate divided into an active area and a non-active area located around the active area; a sensing pattern part including first sensing cells arranged in the active area of the first transparent substrate in a longitudinal direction, a second transparent substrate provided on the first sensing cells, and second sensing cells arranged on the second transparent substrate in a lateral direction; and first sensing lines and second sensing lines provided in the non-active area of the first transparent substrate to connect the first sensing cells and the second sensing cells to an external driving circuit, respectively, wherein an extended transparent substrate extending from the second transparent substrate along interconnection wires of the second sensing cells is formed in the non-active area of the first transparent substrate.

A touch panel according to the present invention includes: a first transparent substrate divided into an active area and a non-active area located around the active area; a sensing pattern part including second sensing cells arranged in the active area of the first transparent substrate in a lateral direction, a second transparent substrate provided on the second sensing cells, and first sensing cells arranged on the second transparent substrate in a longitudinal direction; and first sensing lines and second sensing lines provided in the non-active area of the first transparent substrate to connect the first sensing cells and the second sensing cells to an external driving circuit, respectively, wherein an extended transparent substrate extending from the second transparent substrate along interconnection wires of the first sensing cells is formed in the non-active area of the first transparent substrate.

In addition, the extended transparent substrate may be provided so as not to form a step with a layer of the second transparent substrate.

In addition, the first sensing lines may be connected to at least one of an uppermost sensing cell and a lowermost sensing cell among the first sensing cells.

In addition, at least some of the first sensing lines and the second sensing lines are formed to vertically overlap each other.

The touch panel may further include a connection part concentrating on a predetermined area so that the first sensing lines and the second sensing lines are connected to the external driving circuit.

In addition, at least some of the first sensing lines and the second sensing lines may be formed at the connection part so as to vertically overlap each other.

### Advantageous Effects

According to the present invention, among sensing lines for connecting a sensing pattern having a two-layer structure with an external driving circuit, sensing lines corresponding to a sensing pattern located in an upper layer are provided on a separate extended upper layer, as opposed to the related art, which makes it possible to omit a separate process for overcoming a step, thereby reducing a metal patterning process and ensuring a competitive price accordingly.

In addition, according to the present invention, an extended upper layer is formed so that sensing lines connected from sensing patterns arranged in a longitudinal direction and connected to each other and sensing lines arranged in a lateral direction and connected to each other are provided on different layers to overlap each other, thereby reducing a width of a non-active area in which the sensing lines are formed.

### DESCRIPTION OF THE DRAWINGS

FIG. 1 is a schematic diagram illustrating an example of a touch panel including a sensing pattern part having a two-layer structure.

FIG. 2 is an enlarged view illustrating a portion of FIG. 1.

FIG. 3 is a schematic cross-sectional view taken along line I-I′ of FIG. 2.

FIG. 4 is a schematic diagram illustrating a touch panel according to an embodiment of the present invention.

FIG. 5 is an enlarged view illustrating a portion A1 of FIG. 4.

FIG. 6 is a schematic cross-sectional view taken along line I-I′ of FIG. 5.

FIG. 7 is a schematic cross-sectional view taken along line I2-I2′ of FIG. 5.

FIG. 8 is a schematic diagram illustrating a touch panel according to another embodiment of the present invention.

FIG. 9 is an enlarged view illustrating a portion A2 of FIG. 8.

FIG. 10 is a schematic cross-sectional view taken along line I3-I3′ of FIG. 9.

### BEST MODE

A touch panel the present invention includes: a first transparent substrate divided into an active area and a non-active area located around the active area; a sensing pattern part that includes first sensing cells arranged in the active area of the transparent substrate in a longitudinal direction, a second transparent substrate provided on the first sensing cells, and second sensing cells arranged on the second transparent substrate in a lateral direction; and first sensing lines and second sensing lines provided in the non-active area of the first transparent substrate to connect the first sensing cells and the second sensing cells to an external driving circuit, respectively, wherein an extended transparent substrate extending from the second transparent substrate along interconnection wires of the second sensing cells is formed in the non-active area of the first transparent substrate.

### MODE OF THE INVENTION

Hereinafter, embodiments of the present invention will be described in detail with reference to the accompanying drawings. The terms indicating directions used in this description are based on a state indicated in the drawings, unless particularly defined or mentioned. The same reference numerals denote the same members throughout the embodiments. For the sake of convenience, the thicknesses or dimensions of each configuration illustrated in the drawings may be exaggerated, and it does not necessarily mean that each configuration must be actually configured with the dimensions or the proportions.

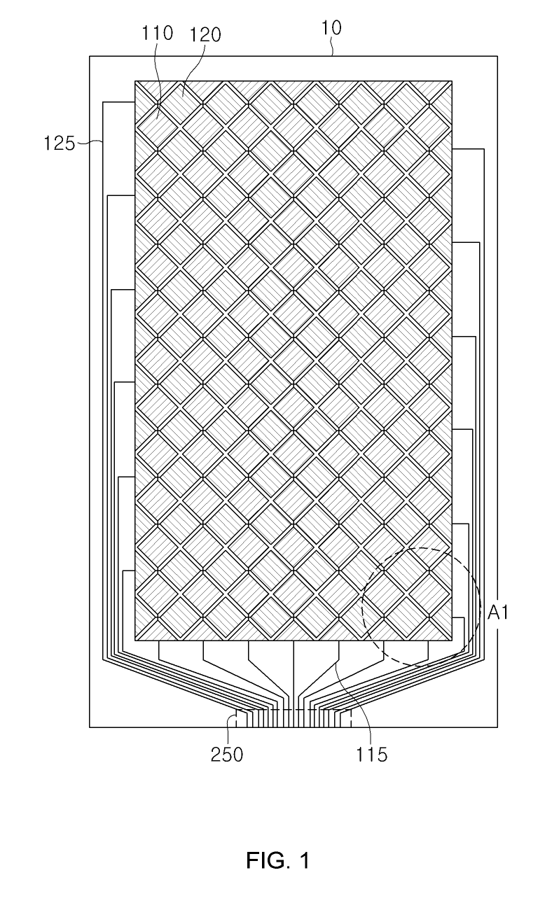

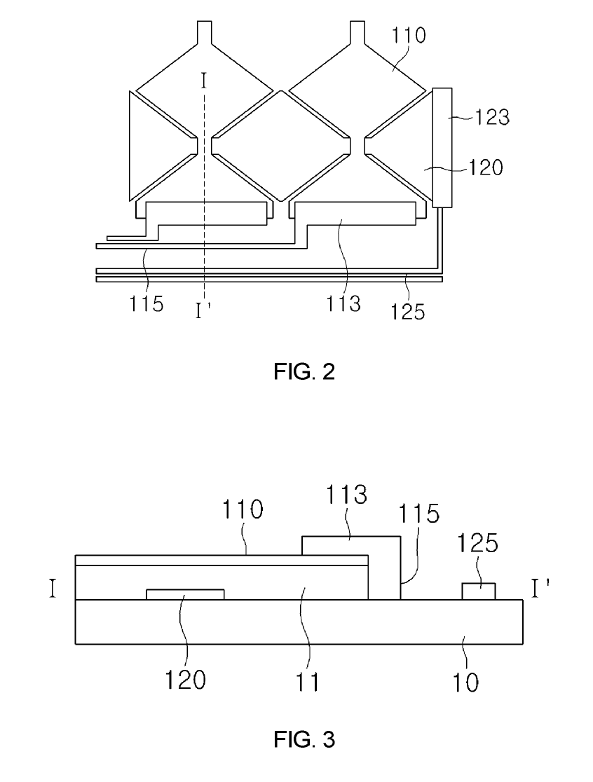

Structural problems that may occur in a touch panel having a two-layer structure will be described with reference to FIGS. 1 to 3. FIG. 1 is a schematic diagram illustrating an example of a touch panel including a sensing pattern part having a two-layer structure, FIG. 2 is an enlarged view illustrating a portion of FIG. 1, and FIG. 3 is a schematic cross-sectional view taken along line I-I′ of FIG. 2.

As illustrated in FIG. 1, the touch panel includes a sensing pattern part including sensing cells 110 and 120 in an active area on a first transparent substrate 10.

The sensing pattern part is divided into first sensing cells 110 arranged in a longitudinal direction and electrically connected to each other and second sensing cells 120 arranged in a lateral direction and electrically connected to each other. The first sensing cells 110 are electrically connected to an external driving circuit (not illustrated) through first sensing lines 115 provided from the uppermost or lowermost first sensing cells 110. The second sensing cells 120 are electrically connected to an external driving circuit (not illustrated) through second sensing lines 125 provided from the left sensing cells or the right second sensing cells 125.

The first sensing lines 115 and the second sensing lines 125 are provided to concentrate on one point (hereinafter referred to as a connection part 250) so as to connect with the external driving circuit.

Referring to FIGS. 2 and 3, the second sensing cells 120 are formed on the first transparent substrate 10, and a second transparent substrate 11 is provided on the second sensing cells 120 in a multilayer structure. The first sensing cells 110 are formed on the second transparent substrate 11. In the case of the sensing pattern part having the two-layer structure as described above, the first sensing cells 110 arranged in the longitudinal direction and connected to each other and the second sensing cells 120 arranged in the lateral direction are located on different layers in the multilayer structure and are insulated from one another by the second transparent substrate 11.

At this time, the second sensing lines 125 electrically connecting the second sensing cells 120 of the lower layer are located on the first transparent substrate 10, as in the second sensing cells 120, so that no step is formed and the second sensing lines 125 are provided within a plane.

However, since the first sensing lines 115 are located on the first transparent substrate 10, unlike the first sensing cells 110 formed on the second transparent substrate 11 of the upper layer, a design for overcoming a stepped structure is needed for electrical connection. For example, a portion of the first sensing line 115 or one of contact points 113 between the first sensing line 115 and the first sensing cells 120 has to be provided in a height direction so as to overcome a step with respect to the first transparent substrate 10, which appears on the end side of the second transparent substrate 11.

However, due to the structure for overcoming the step, a separate wiring process is required on each of the first transparent substrate 10 and the second transparent substrate 11. In addition, there is a high probability that electrical connection will be broken at a point where the step is formed, thus increasing a defect rate of products.

The respective embodiments according to the present invention are intended to overcome such a step structure and will be described in detail below.

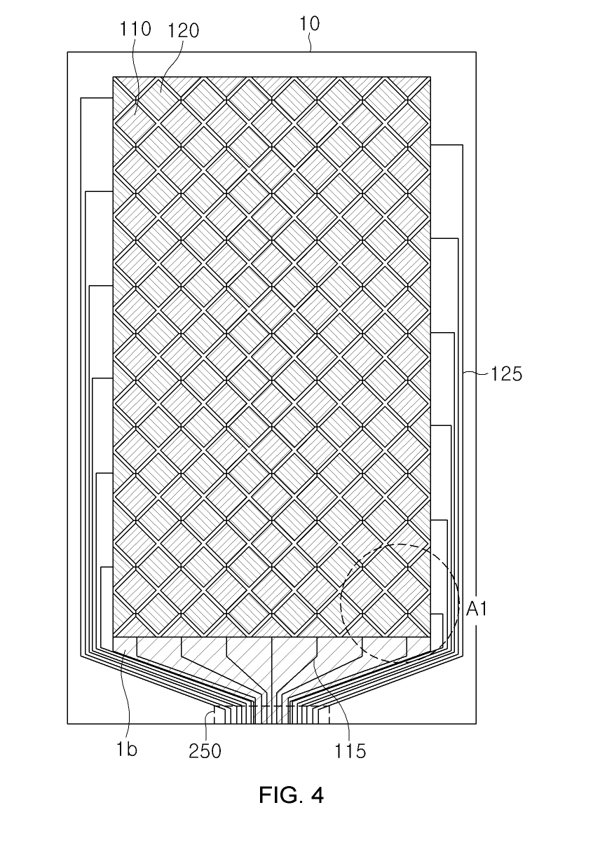

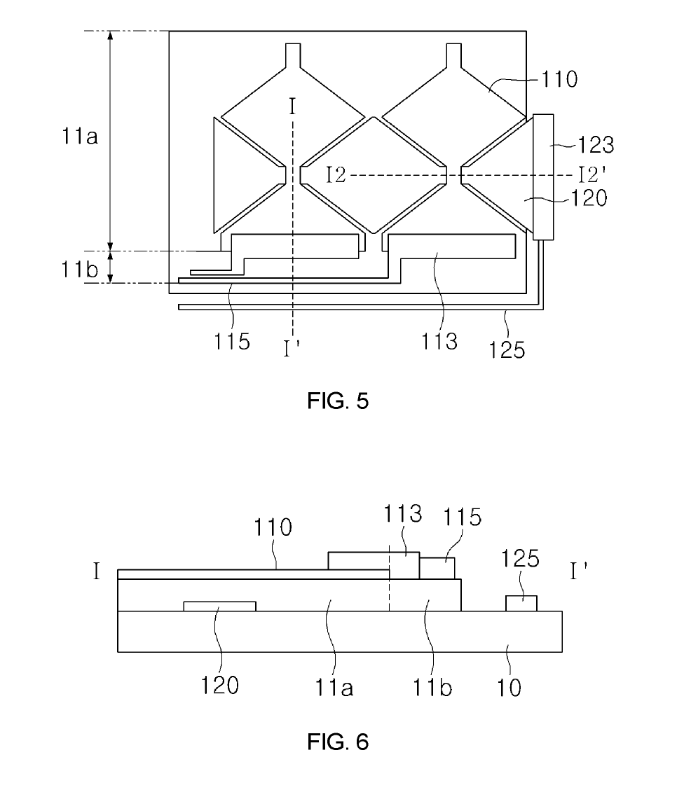

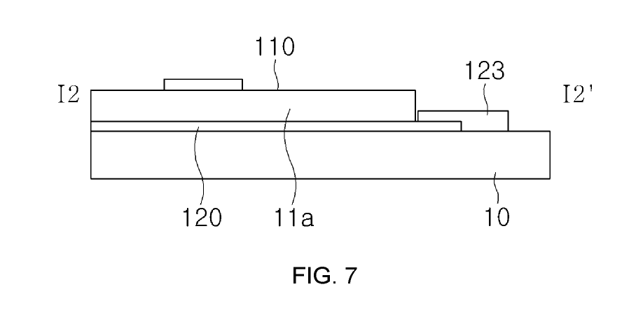

A touch panel according to an embodiment will be described below with reference to FIGS. 4 to 7. FIG. 4 is a schematic diagram illustrating a touch panel according to an embodiment of the present invention, and FIG. 5 is an enlarged view illustrating a portion A1 of FIG. 4. In addition, FIG. 6 is a schematic cross-sectional view taken along line I-I′ of FIG. 5, and FIG. 7 is a schematic cross-sectional view taken along line I2-I2′ of FIG. 5.

As described above, a first transparent substrate 10 may be divided into an active area and a non-active area located around the active area. A sensing pattern part including first sensing cells 110 and second sensing cells 120 is provided in the active area. In addition, the sensing pattern part is divided into the first sensing cells 110 arranged in a longitudinal direction and electrically connected to each other and the second sensing cells 120 arranged in a lateral direction and electrically connected to each other. The first sensing cells 110 are electrically connected to an external driving circuit (not illustrated) through a first sensing line 115 provided from the uppermost sensing cell or the lowermost first sensing cell 110. The second sensing cells 120 are electrically connected to an external driving circuit (not illustrated) through second sensing lines 125 provided from the left sensing cells or the right second sensing cells 125. Various known structures may be applied to the structure for connecting the respective sensing cells, and a detailed description thereof will be omitted.

As illustrated in FIGS. 4 and 5, in the sensing pattern part according to the present embodiment, the second sensing cells 120 are located on the lower layer, that is, the first transparent substrate 10, and the first sensing cells 110 are located on the upper layer, that is, the second transparent substrate 11a. The second transparent substrate 11a according to the present embodiment differs from the touch panel having the two-layer structure in that an extended transparent substrate 11b is further formed.

The extended transparent substrate 11b extends from the outer end of the second transparent substrate 11a toward the non-active area in which the first sensing line 115 and the second sensing line 125 are formed. The extended transparent substrate 11b extends along a wiring route of the first sensing line 115 for electrically connecting the first sensing cells 110 provided in the lower layer. Specifically, the extended transparent substrate 11b is formed below the first sensing lines 115 provided from the lowermost or uppermost first sensing cells 110, from which the first sensing line 115 begins, to the connection part 250.

Specifically, as illustrated in FIG. 6, the touch panel according to the present embodiment further includes an extended transparent substrate 11b extending from the side end of the second transparent substrate 11a. Unlike the above-described structure for overcoming the step, the first sensing lines 115 and the contact points 113 according to the present embodiment are all formed on the extended transparent substrate 11b. Therefore, the structure for overcoming the step is not required for the first sensing line 115 and the contact point 113 thereof.

In addition, as illustrated in FIG. 7, the second sensing line 125 for electrically connecting the second sensing cells 120 and the contact point 123 are all formed on the same plane as the second sensing cells 120, that is, the first transparent substrate 10, and thus the stepped structure is not formed.

Consequently, due to the extended transparent substrate 11b, the first sensing lines 115 and the second sensing lines 125 are located on the same plane as the first sensing cells 110 and the second sensing cells 120 or are formed in a state in which the step is minimized. Thus, a process for overcoming the stepped structure is not required, and a metal trace process for forming the first sensing lines 115 and the second sensing lines 125 is simultaneously performed, thereby reducing the whole process.

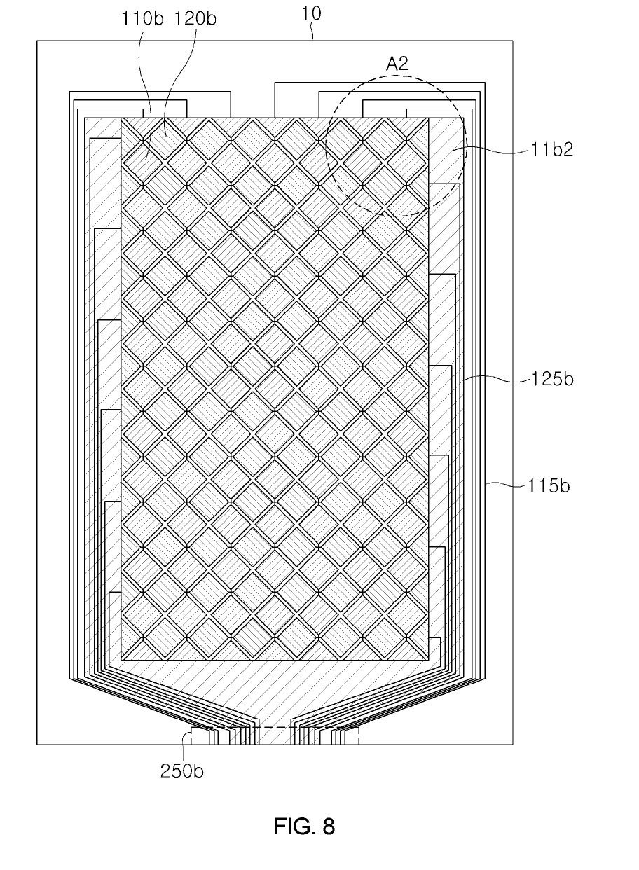

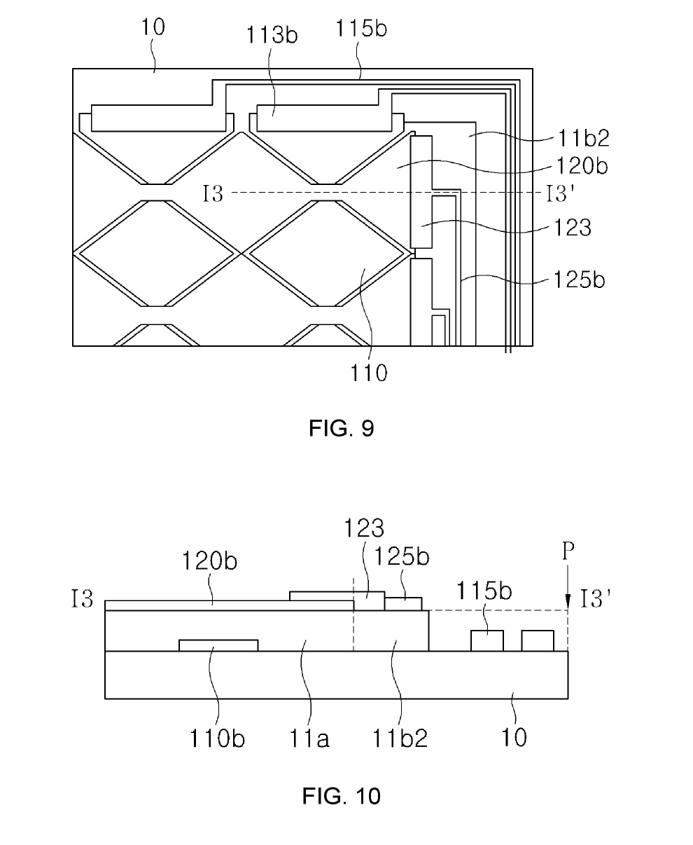

A touch panel according to another embodiment of the present invention will be described below with reference to FIGS. 8 to 10. FIG. 8 is a schematic diagram illustrating a touch panel according to another embodiment of the present invention, FIG. 9 is an enlarged view illustrating a portion A2 of FIG. 8, and FIG. 10 is a schematic cross-sectional view taken along line I3-I3′ of FIG. 9.

Referring to FIG. 8, the touch panel according to the present embodiment differs from the embodiment of FIG. 4 in that a first sensing line 115b starts wiring from above first sensing cells 110b. As illustrated in FIGS. 9 and 10, the touch panel according to the present embodiment differs from the embodiment of FIG. 4 in that the first sensing cells 110b are formed on a lower layer, that is, a first transparent substrate 10, and second sensing cells 120b are formed on an upper layer, that is, a second transparent substrate 11a. The first sensing line may start wiring from the lowermost cells as in the above-described embodiment, may start wiring from the uppermost cells as in the present embodiment, and may start wiring from both the uppermost cells and the lowermost cells.

In addition, an extended transparent substrate 11b2 extends from the second transparent substrate 11a to the left and right sides with reference to FIG. 8, and is formed along a wiring path of a second sensing line 125b.

The other components are not significantly different from those of the previous embodiment.

As in the previous embodiment, even in the case of the touch panel according to the present embodiment, due to the extended transparent substrate 11b2, the first sensing lines 115b and the second sensing lines 125b are located on the same plane as the first sensing cells 110b of the lower layer and the second sensing cells 120b of the upper layer or are formed in a state in which the step is minimized. Thus, a process for overcoming the stepped structure is not required, and a metal trace process for forming the first sensing lines 115b and the second sensing lines 125b is simultaneously performed, thereby reducing the whole process.

Meanwhile, as illustrated in FIG. 10, at least some of the first sensing lines 115b and the second sensing lines 125b may be formed to vertically overlap each other by further extending the extended transparent substrate 11b2 on the first sensing line 115b or forming the first sensing lines 115b below the extended transparent substrate 11b2. For example, the first sensing line 115b and the second sensing line 125b may be formed on different layered structures and insulated from each other so that the wiring paths overlap each other, or the first sensing lines 115b and the second sensing line 125b may be formed to overlap each other on a connection part 250b of FIG. 8, thereby reducing the size of the non-active area. This is also applicable to the above-described embodiment of FIG. 4.

While the present invention has been particularly shown and described with reference to exemplary embodiments thereof, it will be understood by those of ordinary skill in the art that various changes in form and details may be made therein without departing from the spirit and scope of the present invention as defined by the following claims.

1.-7. (canceled)

8. A touch panel comprising:
a first transparent substrate divided into an active area and a non-active area located around the active area;
a sensing pattern part comprising first sensing cells arranged in the active area of the first transparent substrate in a longitudinal direction, a second transparent substrate provided on the first sensing cells, and second sensing cells arranged on the second transparent substrate in a lateral direction; and
first sensing lines and second sensing lines provided in the non-active area of the first transparent substrate to connect the first sensing cells and the second sensing cells to an external driving circuit, respectively,
wherein an extended transparent substrate extending from the second transparent substrate along interconnection wires of the second sensing cells is formed in the non-active area of the first transparent substrate.

9. The touch panel of claim 8, wherein the extended transparent substrate is provided so as not to form a step with a layer of the second transparent substrate.

10. The touch panel of claim 8, wherein the first sensing lines are connected to at least one of an uppermost sensing cell and a lowermost sensing cell among the first sensing cells.

11. The touch panel of claim 8, wherein at least some of the first sensing lines and the second sensing lines are formed to vertically overlap each other.

12. The touch panel of claim 8, further comprising a connection part concentrating on a predetermined area so that the first sensing lines and the second sensing lines are connected to the external driving circuit.

13. The touch panel of claim 12, wherein at least some of the first sensing lines and the second sensing lines are formed at the connection part so as to vertically overlap each other.

14. A touch panel comprising:
a first transparent substrate divided into an active area and a non-active area located around the active area;
a sensing pattern part comprising second sensing cells arranged in the active area of the first transparent substrate in a lateral direction, a second transparent substrate provided on the second sensing cells, and first sensing cells arranged on the second transparent substrate in a longitudinal direction; and
first sensing lines and second sensing lines provided in the non-active area of the first transparent substrate to connect the first sensing cells and the second sensing cells to an external driving circuit, respectively,
wherein an extended transparent substrate extending from the second transparent substrate along interconnection wires of the first sensing cells is formed in the non-active area of the first transparent substrate.

15. The touch panel of claim 14, wherein the extended transparent substrate is provided so as not to form a step with a layer of the second transparent substrate.

16. The touch panel of claim 14, wherein the first sensing lines are connected to at least one of an uppermost sensing cell and a lowermost sensing cell among the first sensing cells.

17. The touch panel of claim 14, wherein at least some of the first sensing lines and the second sensing lines are formed to vertically overlap each other.

18. The touch panel of claim 14, further comprising a connection part concentrating on a predetermined area so that the first sensing lines and the second sensing lines are connected to the external driving circuit.

19. The touch panel of claim 18, wherein at least some of the first sensing lines and the second sensing lines are formed at the connection part so as to vertically overlap each other.
